(19) United States
(12) Patent Application Publication
(10) Pub. No.: US 2023/0103320 A1
(43) Pub. Date: Apr. 6, 2023

(54) HYDRAULIC BRAKE SYSTEM

(71) Applicants: TOYOTA JIDOSHA KABUSHIKI KAISHA, Toyota-shi (JP); ADVICS CO., LTD., Kariya-shi (JP)

(72) Inventors: Naoki YABUSAKI, Toyota-shi (JP); Tsuyoshi Otake, Kariya-shi (JP); Atsushi Takahashi, Kariya-shi (JP)

(73) Assignees: TOYOTA JIDOSHA KABUSHIKI KAISHA, Toyota-shi (JP); ADVICS CO., LTD., Kariya-shi (JP)

(21) Appl. No.: 17/958,669

(22) Filed: Oct. 3, 2022

(30) Foreign Application Priority Data
Oct. 4, 2021 (JP) 2021-163603

(51) Int. Cl. B60T 13/74; B60T 13/14; F16D 65/28

(52) U.S. Cl. CPC B60T 13/745; B60T 13/148; F16D 65/28; F16D 2121/04

(57) ABSTRACT

A hydraulic brake system includes: a plurality of hydraulic brakes respectively provided for a plurality of wheels of a vehicle, each of which is configured to reduce rotation of a corresponding one of the wheels by a hydraulic pressure in a hydraulic-pressure chamber of a wheel cylinder; and a plurality of electric cylinder devices each of which is provided for one or more of the plurality of hydraulic brakes. Each electric cylinder device includes: a housing; a piston fluid-tightly and slidably disposed in the housing; an electric motor as a drive source; a rotation-linear motion converting mechanism configured to convert a rotational motion of the electric motor to a linear motion of the piston; and a volume change chamber disposed forward of the piston and connected to the hydraulic-pressure chamber of the wheel cylinder of each of the one or more of the plurality of hydraulic brakes.

### CROSS REFERENCE TO RELATED APPLICATION

The present application claims priority to Japanese Patent Application No. 2021-163603, which was filed on Oct. 4, 2021, the disclosure of which is herein incorporated by reference in its entirety.

### BACKGROUND

### Technical Field

The following disclosure relates to a hydraulic brake system configured to apply a braking force generated by a hydraulic pressure to a vehicle.

### Description of Related Art

Patent Document 1 (Japanese Patent Application Publication No. 8-26099) describes a hydraulic brake system that does not include a master cylinder but includes a plurality of hydraulic brakes and pressure generators respectively connected to wheel cylinders of the plurality of hydraulic brakes. The Patent Document 1 does not describe a configuration of the pressure generators.

### SUMMARY

An aspect of the present disclosure relates to a novel hydraulic brake system not including a master cylinder.

A hydraulic brake system according to the present disclosure includes a plurality of hydraulic brakes respectively provided for a plurality of wheels and a plurality of electric cylinder devices each of which is connected to one or more of the plurality of hydraulic brakes. Each of the plurality of electric cylinder devices of the hydraulic brake system includes: a housing; a piston fluid-tightly and slidably disposed in the housing; an electric motor as a drive source; a rotation-linear motion converting device configured to convert a rotational motion of the electric motor to a linear motion of the piston; and a volume change chamber disposed forward of the piston and connected to a hydraulic pressure chamber of a wheel cylinder of each of the one or more of the plurality of hydraulic brakes. The hydraulic brake system including a plurality of hydraulic brakes and a plurality of electric cylinder devices is not described in the Patent Document 1 described above. The hydraulic brake system according to the present disclosure is novel.

### BRIEF DESCRIPTION OF THE DRAWINGS

The objects, features, advantages, and technical and industrial significance of the present disclosure will be better understood by reading the following detailed description of embodiments, when considered in connection with the accompanying drawings, in which:

FIG. 1 a conceptual view of a hydraulic brake system according to one embodiment of the present disclosure;

FIG. 2 is an exploded side view of an electric cylinder device of the hydraulic brake system;

FIG. 3 is a view of a vehicle on which the hydraulic brake system is installed;

FIG. 4 is a view of another vehicle on which the hydraulic brake system is installed;

FIG. 5 is a view of still another vehicle on which the hydraulic brake system is installed;

FIG. 6 is a view of yet another vehicle on which the hydraulic brake system is installed;

FIG. 7 is a flowchart representing a normal-condition brake control program stored in a driving support ECU of the hydraulic brake system;

FIG. 8 is a flowchart representing a motor control program stored in brake ECUs of the hydraulic brake system;

FIG. 9 is a flowchart representing a slip reduction control program stored in the brake ECUs of the hydraulic brake system; and

FIG. 10 is a flowchart representing an abnormal-condition brake control program stored in the brake ECUs of the hydraulic brake system.

### DETAILED DESCRIPTION OF THE EMBODIMENTS

Referring to the drawings, there will be hereinafter described a hydraulic brake system according to one embodiment of the present disclosure.

The hydraulic brake system according to the present embodiment does not include a manual hydraulic pressure source configured to generate a hydraulic pressure based on an operation of a brake operation member by a driver. One example of such a manual hydraulic pressure source is a master cylinder.

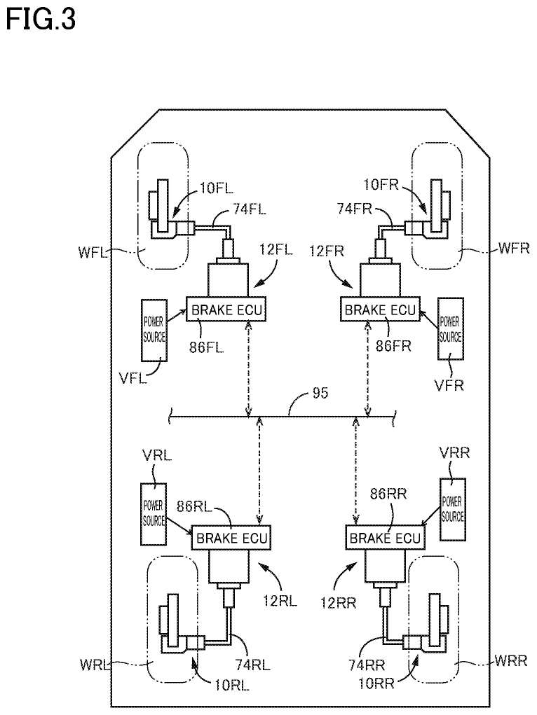

As illustrated in FIG. 3, the present hydraulic brake system includes: hydraulic brakes 10FL, 10FR, 10RL, 10RR respectively provided for four wheels of a vehicle, i.e., a front left wheel WFL, a front right wheel WFR, a rear left wheel WRL, and a rear right wheel WRR; and electric cylinder devices 12FL, 12FR, 12RL, 12RR respectively connected to the hydraulic brakes 10FL, 10FR, 10RL, 10RR in one-to-one correspondence. In the following description, in a case where distinction of the wheels is not necessary or components, devices, etc., corresponding to the respective wheels are collectively referred to, suffixes (FL, FR, RL, RR, F, R) indicative of the corresponding wheels are omitted where appropriate.

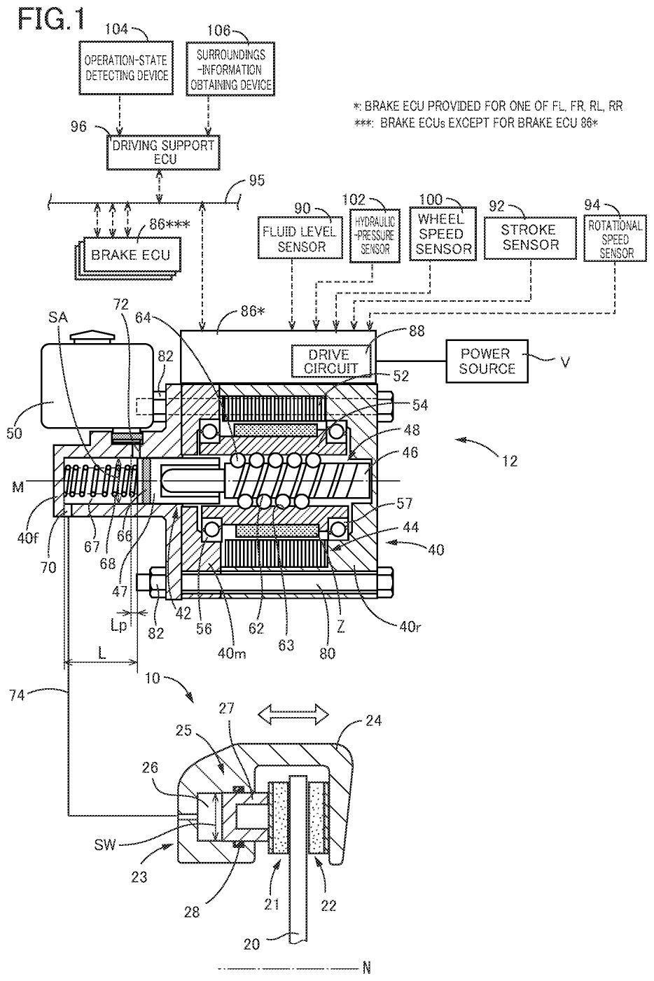

As illustrated in FIG. 1, the hydraulic brake 10 according to the present embodiment includes: a pair of friction pads 21, 22 functioning as friction engagement members and disposed on opposite sides of a brake rotor 20, which is rotatable with the wheel W; and a pressing device 23 configured to press the friction pads 21, 22 against the brake rotor 20. The pressing device 23 includes: a caliper 24 held by a non-rotation member so as to be movable in a direction parallel to a rotation axis N of the wheel (hereinafter referred to as “rotation axis direction”); and a wheel cylinder 25 provided inside the caliper 24. The wheel cylinder 25 includes: a piston 27 fluid-tightly and slidably disposed in a cylinder bore formed in the caliper 24 (hereinafter referred to as “wheel-side piston 27” where appropriate); and a hydraulic pressure chamber 26 provided rearward of the wheel-side piston 27. A piston seal 28 is attached to the caliper 24.

When a hydraulic pressure is supplied to the hydraulic pressure chamber 26 of the wheel cylinder 25, the wheel-side piston 27 is moved forward and the caliper 24 is moved in the rotation axis direction. The pair of friction pads 21, 22 are pressed against the brake rotor 20 by a pressing force Fp corresponding to a hydraulic pressure P in the hydraulic pressure chamber 26, so that the friction pads 21, 22 are brought into frictional engagement with the brake rotor 20 to thereby reduce rotation of the wheel. The hydraulic pressure P in the hydraulic pressure chamber 26 is increased or decreased to increase or decrease the pressing force Fp.

The electric cylinder device 12 includes: a housing 40; a piston member 42 (as one example of a piston) fluid-tightly and slidably disposed in the housing 40 (hereinafter referred to as “electric piston member 42”); an electric motor 44 as a drive source; a rotation-linear motion converting device 48 configured to perform conversion between a rotational motion of the electric motor 44 and a linear motion of the electric piston member 42; and a reservoir 50. The electric piston member 42 is held by the housing 40 so as to be unrotatable about an axis M of the electric piston member 42 and movable in a direction parallel to the axis M.

The reservoir 50 stores a working fluid used in the hydraulic brake 10. The reservoir 50 stores a sufficient amount of the working fluid that enables a certain degree of braking even after the used amount of the working fluid is changed due to wear of the friction pads 21, 22 or due to elastic deformation of the friction pads 21, 22 caused by pressurization or even after the working fluid leaks out of the reservoir 50. Further, the working fluid returned from the wheel cylinder 25 of the hydraulic brake 10 that is connected to the electric cylinder device 12 is stored in the reservoir 50.

In the present embodiment, the electric piston member 42 is constituted by a piston portion 47 and a piston rod portion 46 (hereinafter simply referred to as “rod portion 46”) engaged with the piston portion 47 so as to be movable with the piston portion 47. It is noted that the piston portion 47 and the rod portion 46 may be formed integrally with each other. It may be considered that the piston portion 47 in the present embodiment is one example of a piston or it may be considered that the electric piston member 42 in the present embodiment is one example of the piston.

The housing 40 includes: a rear housing 40r (as one example of a first housing) in which the electric motor 44 is housed; a front housing 40f (as one example of a second housing) having a cylindrical shape with a closed bottom; and an intermediate housing 40m located between the front housing 40f and the rear housing 40r. The rear housing 40r, the intermediate housing 40m, and the front housing 40f are separable from one another.

The electric motor 44 is disposed radially outward of the rod portion 46 so as to be coaxial with the electric piston member 42. The electric motor 44 includes: a plurality of coils 52 disposed mainly in the rear housing 40r and held by the rear housing 40r and the intermediate housing 40m; and a generally cylindrical rotor 54 disposed radially inward of the coils 52 and including a plurality of magnets Z. The plurality of coils 52 functions as a stator. The rotor 54 is rotatably held by the rear housing 40r and the intermediate housing 40m via a pair of bearings 56, 57 disposed so as to be spaced apart from each other in the direction parallel to the axis M. The magnets Z of the rotor 54 may be attached to the outer circumferential surface of the rotor 54 or may be embedded in the rotor 54.

The rotation-linear motion converting device 48 is provided between the inner circumferential portion of the rotor 54 and the outer circumferential portion of the rod portion 46. The rotation-linear motion converting device 48 in the present embodiment includes a ball screw mechanism that includes an external thread portion 62 formed on the outer circumferential portion of the rod portion 46, an internal thread portion 63 formed on the inner circumferential portion of the rotor 54, and a plurality of balls 64 interposed between the external thread portion 62 and the internal thread portion 63.

A cylinder bore is formed in the front housing 40f. The electric piston member 42 is fluid-tightly and slidably held in the cylinder bore via a seal member 66. A portion of the cylinder bore located forward of the electric piston member 42 is a volume change chamber 67. A return spring 68 is provided between the electric piston member 42 and the bottom of the front housing 40f. The return spring 68 applies, to the electric piston member 42, an elastic force in a direction in which the electric piston member 42 moves backward.

In the front housing 40f (corresponding to a portion of the housing 40 surrounding the volume change chamber 67), a front port 70 and a rear port 72 are formed at respective positions of the front housing 40f that are spaced apart from each other in the direction parallel to the axis M. The hydraulic pressure chamber 26 of the wheel cylinder 25 is directly connected to the front port 70 via a fluid passage 74, and the reservoir 50 is connected to the rear port 72. The rear port 72 may also be referred to as an idle port.

The front port 70 is open all the time, and the volume change chamber 67 is all the time in communication with the hydraulic pressure chamber 26 of the wheel cylinder 25 via the fluid passage 74. In the present embodiment, no electromagnetic valve and the like are provided in the fluid passage 74.

The rear port 72 is open when the electric piston member 42 is located at its rear end position. The rear port 72 is closed when the electric piston member 42 move forward, so that the hydraulic pressure is generated in the volume change chamber 67. The rear end position of the electric piston member 42 is a position at which the electric piston member 42 comes into contact with a stopper (not illustrated) provided in the housing 40.

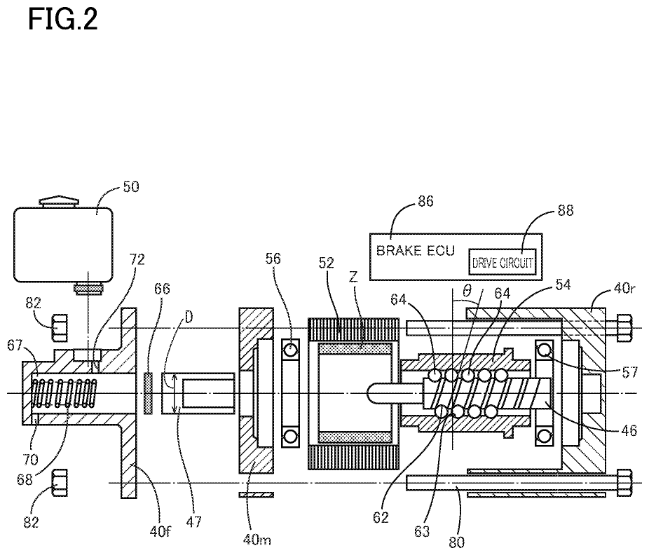

In the electric cylinder device 12 according to the present embodiment, a diameter D (FIG. 2) of the piston portion 47 of the electric piston member 42 is small, and a maximum stroke L (FIG. 1) of the electric piston member 42 is large. For instance, the maximum stroke L of the electric piston member 42 is considered as a distance between the front end surface of the piston portion 47 and the bottom surface of the front housing 40f when the electric piston member 42 is located at the rear end position. A full stroke, which is the maximum stroke L, includes an idle stroke Lp that is a stroke from the rear end position of the electric piston member 42 to when the idle port 72 is closed.

Here, there is considered a hydraulic brake system including a master cylinder as a manual hydraulic pressure source, for instance. In this hydraulic brake system, a brake pedal, which is a brake operation member operable by a driver, is coupled to a pressurizing piton of the master cylinder, and the pressurizing piston is moved forward in accordance with depression of the brake pedal. Because the brake pedal is depressed by the driver, the maximum stroke of the brake pedal is determined based on human engineering or the like, and the maximum stroke of the pressurizing piston is determined based on the maximum stroke of the brake pedal. Accordingly, the maximum stroke of the pressurizing piston of the master cylinder is usually 50 mm or smaller.

In contrast, the electric piston member 42 of the electric cylinder device 12 in the present embodiment is moved not by depression of the brake operation member but by the electric motor 44. It is thus possible to increase the maximum stroke without restrictions in terms of human engineering or the like. The increase in the maximum stroke of the electric piston member 42 enables the working fluid to be supplied to the wheel cylinder 25 in an amount required by the wheel cylinder 25 even if the diameter D of the electric piston member 42, i.e., a pressure receiving area SA of the electric piston member 42, is small. In other words, the maximum stroke of the electric piston member 42 is made large for supplying a required amount of the working fluid to the wheel cylinder 25, whereby the pressure receiving area SA (the diameter D) of the piston portion 47 can be made small.

The reduction in the pressure receiving area SA of the electric piston member 42 can increase a value SW/SA obtained by dividing a pressure receiving area SW of the wheel-side piston 27 of the wheel cylinder 25 of the hydraulic brake 10 by the pressure receiving area SA of the electric piston member 42, i.e., a pressure receiving area ratio SW/SA. Where the pressing force Fp required in the wheel cylinder 25 is the same, an axial force Fs applied to the rod portion 46 of the rotation-linear motion converting device 48 can be decreased, and power consumption of the electric motor 44 can be accordingly decreased.

The reasons why the axial force Fs can be decreased by increasing the pressure receiving area ratio SW/SA will be hereinafter described in detail.

(a) As described above, the pressure receiving area ratio SW/SA is increased, and the axial force Fs applied to the rod portion 46 is decreased, so that a gear ratio of the electric motor 44 is decreased or the output of the electric motor 44 is decreased. The gear ratio of the electric motor 44 is represented as “the rotational speed of the electric motor 44/the rotational speed of the rod portion 46”, for instance.

If the axial force Fs applied to the rod portion 46 is large, it is considered to provide a speed reducer between the electric motor 44 and the rotation-linear motion converting device 48 and to increase a speed reduction ratio of the speed reducer. The speed reducer usually includes involute gears. The involute gears transmit a force while meshing teeth of the involute gears are in slipping contact. Further, a rotational resistance is generated due to a thrust load of the gears of the speed reducer or due to friction caused by push and pull between shafts of the gears. This leads to an increased energy consumption amount by the speed reducer. Accordingly, when the speed reduction ratio of the speed reducer is made large and the efficiency in the speed reducer is largely lowered, the transmission efficiency of the electric motor 44 is largely lowered. The transmission efficiency of the electric motor 44 is represented as “the energy transmitted to the piston portion 47/the energy supplied to the electric motor 44”, for instance.

In contrast, the axial force Fs is deceased in the present embodiment. This enables a decrease in the speed reduction ratio, eliminates the provision of the speed reducer, or decreases the output of the electric motor 44, for instance, so that the transmission efficiency of the electric motor 44 can be accordingly increased. FIGS. 1 and 2 illustrate a configuration in which the speed reducer is not provided for the electric cylinder device 12.

(b) The decrease in the axial force Fs applied to the rod portion 46 enables a decrease in the diameter of the rod portion 46 of the rotation-linear motion converting device 48. This leads to an increase in a lead angle while obviating a decrease in a speed reduction ratio of the rotation-linear motion converting device 48, so that the transmission efficiency of the electric motor 44 can be increased. The speed reduction ratio of the rotation-linear motion converting device 48 is represented as “the movement speed of the rod portion 46/(the lead×the input rotational speed of the rotation-linear motion converting device 48)”, for instance.

If the axial force Fs is large, the balls 64 of the ball screw mechanism need to have a larger size and the diameter of the rod portion 46 needs to be made larger. Under the same lead angle, the increase in the diameter of the rod portion 46 leads to an increase in the lead, so that the speed reduction ratio of the rotation-linear motion converting device 48 is lowered. In this case, it is required to increase the gear ratio of the electric motor 44 or to increase the output of the electric motor 44. If the lead angle is made small, the speed reduction ratio of the rotation-linear motion converting device 48 is increased, and the gear ratio of the electric motor 44 can be decreased. In this case, however, the transmission efficiency of the electric motor 44 is lowered arising from a decrease in the lead angle.

In contrast, the axial force Fs can be decreased in the electric cylinder device 12 of the present embodiment. This enables a decrease in the diameter of the rod portion 46 and an increase in the lead angle while preventing the speed reduction ratio of the rotation-linear motion converting device 48 from being lowered. It is thus possible to enhance the transmission efficiency of the electric motor 44.

In other words, the position of the rotation-linear motion converting device 48 of the electric cylinder device 12 is designed such that the axial force Fs applied to the rotation-linear motion converting device 48 can be made as small as possible. For instance, the electric motor 44, the rotation-linear motion converting device 48, and the piston portion 47 are disposed in series in the electric cylinder device 12, and the hydraulic brake 10 is connected to the volume change chamber 67 located forward of the piston portion 47. In the present hydraulic brake system, the pressure receiving area ratio is large, so that the pressing force by which the friction pads 21, 22 are pressed against the brake rotor 20 can be made large with respect to the hydraulic pressure in the volume change chamber 67. For this reason, the rotation-linear motion converting device 48 is disposed upstream of the piston portion 47 and downstream of the electric motor 44 or the speed reducer.

(c) In the electric cylinder device 12, the electric piston member 42 has a large stroke, and the cylinder bore formed in the front housing 40f has a large axial length. The position of the idle port 72 in the housing 40 of the electric cylinder device 12 is constant irrespective of the axial length of the cylinder bore formed in the front housing 40f. In this configuration, a ratio of the idle stroke Lp with respect to the maximum stroke L of the electric piston member 42, i.e., a ratio Lp/L, decreases with an increase in the maximum stroke L, thus resulting in enhanced transmission efficiency of the electric motor 44.

In the thus configured electric cylinder device 12, the transmission efficiency of the electric motor 44 can be enhanced, and power consumption of the electric motor 44 can be reduced.

The decrease in the gear ratio of the electric motor 44 eliminates provision of the speed reducer or enables a size reduction of the speed reducer, thus resulting in a reduction in size and weight of the electric cylinder device 12. Further, the number of components of the electric cylinder device 12 can be reduced.

Moreover, the lead angle θ (FIG. 2) can be made large in the rotation-linear motion converting device 48, so that forward and reverse efficiency, namely, forward efficiency (the wheel cylinder pressure/the axial force) and reverse efficiency (the axial force/the wheel cylinder pressure) can be increased.

In the description above, the rotation-linear motion converting device 48 is the ball screw mechanism. The rotation-linear motion converting device 48 may include a trapezoidal screw mechanism. The rotation-linear motion converting device 48 including the trapezoidal screw mechanism also enjoys advantages similar to those described above, namely, the enhanced transmission efficiency of the electric motor 44 and the reduction in power consumption of the electric motor 44.

In the trapezoidal screw mechanism, in particular, grease, as a lubricant, plays an important role for reducing a frictional force that acts between the external thread portion and the internal thread portion. The frictional force is typically larger when a surface pressure that acts between the external thread portion and the internal thread portion is large than when the surface pressure is small. When the surface pressure is less than a set value, grease provides an appropriate effect of lubrication between the external thread portion and the internal thread portion. When the surface pressure becomes greater than or equal to the set value, the temperature of grease is increased and the viscosity of grease is lowered, resulting in a lowered lubrication effect. Consequently, the frictional force that acts between the external thread portion and the internal thread portion is increased, causing chipping of the external thread portion or the internal thread portion, for instance. (This state will be referred to as “grease shortage” where appropriate.)

To reduce the surface pressure that acts between the external thread portion and the internal thread portion, the diameter of the rod portion 46 may be increased to thereby increase a sliding area between the external thread portion and the internal thread portion, so that the frictional force is reduced. This, however, raises other problems such as an increase in the size of the electric cylinder device 12 and a change in the speed reduction ratio of the rotation-linear motion converting device 48.

In the present embodiment, the axial force Fs applied to the rod portion 46 can be made small. Accordingly, the surface pressure can be lowered to thereby prevent the viscosity of grease from being lowered, so that the frictional force acting between the external thread portion and the internal thread portion can be reduced. Further, grease is prevented from being degraded by preventing overheating of grease. Typically, the grease shortage described above tends to occur when the lead angle is small. Because the lead angle can be made large in the present embodiment, the grease shortage is not likely to occur, so that the frictional force can be effectively reduced.

In the rotation-linear motion converting device 48 including the ball screw mechanism, grease is used to reduce a sliding resistance between the balls 64 and the external and internal thread portions 62, 63 of the ball screw mechanism. Also in this case, the similar advantages can be obtained owing to the decreased axial force Fs.

As illustrated in FIG. 2, the electric cylinder device 12 of the present embodiment is easily separably constructed. Specifically, the rear housing 40r, the intermediate housing 40m, and the front housing 40f are coupled by a coupler. The coupler may be configured to include a plurality of screw members 80 extending in the axial direction and a plurality of nut members 82 threadedly engaged with the screw members 80.

Inside the rear housing 40r, the intermediate housing 40m, and the front housing 40f, the bearings 56, 57, the electric motor 44 (the coils 52 and the rotor 54), the rod portion 46, the piston portion 47, the seal member 66, the balls 64, etc., are easily separably assembled. By detaching the nut members 82, the electric cylinder device 12 is disassembled into the front housing 40f, the intermediate housing 40m, and the rear housing 40r, thus enabling removal of the constituent elements of the electric cylinder device 12.

The electric cylinder device 12 is provided not in the caliper 24 but in the fluid passage 74 that extends from the caliper 24. In an arrangement in which an electric actuator of an electric brake for reducing rotation of the wheel W is provided in the caliper 24, the electric actuator needs to be hermetically sealed or unitized for preventing the electric actuator from being splashed with water and mud. In the present embodiment, the electric cylinder device 12 is less likely to be splashed with water, mud or the like, as compared with the electric actuator of the electric brake, thus reducing the necessity of unitizing the electric cylinder device 12 or hermetically sealing the housing.

In the present embodiment, no electromagnetic valve is provided on the downstream side of the electric cylinder device 12. This eliminates a problem of a malfunction of the electromagnetic valve caused by entry of foreign matters into an orifice of the electromagnetic valve when the electric cylinder device 12 is disassembled.

The electric cylinder device 12 is constructed so as to be easily disassembled as described above, and the constituent components of the electric cylinder device 12 can undergo maintenance individually. In a case where one of the constituent components suffers from a malfunction, the whole cylinder device 12 need not be replaced but the malfunctioning constituent component in question can be replaced, for instance. This is advantageous for the user in terms of a reduction in the cost of maintenance of the vehicle and reduces wastes to be disposed of The electric cylinder device 12 is provided near the wheel in the present embodiment, facilitating maintenance work of the electric cylinder device 12.

As illustrated in FIGS. 1 and 3, brake ECUs 86 are provided for the electric cylinder devices 12 in one-to-one correspondence. Each brake ECU 86 functions as a controller and is constituted principally by a computer. The electric cylinder devices 12 are controlled respectively by the corresponding brake ECUs 86. Each brake ECU 86 includes, for instance, a drive circuit 88 for an inverter. The drive circuit 88 is controlled to control a supply current to the electric motor 44, so that the electric motor 44 is controlled.

To each brake ECU 86, there are connected a fluid level sensor 90, a stroke sensor 92, and a rotational speed sensor 94, a wheel speed sensor 100 (as one example of a wheel speed detecting device), and a hydraulic pressure sensor 102, for instance. The fluid level sensor 90, the stroke sensor 92, and the rotational speed sensor 94 are constituent elements of the electric cylinder device 12.

The fluid level sensor 90 is configured to detect position of a fluid surface of the working fluid in the reservoir 50, namely, to detect a fluid level in the reservoir 50. For instance, the fluid level sensor 90 may detect the fluid level optically or magnetically. The fluid level sensor 90 may detect the fluid level utilizing a capacitance, ultrasonic waves, a pressure, etc. The fluid level sensor 90 may be of a contact type or a non-contact type. The fluid level sensor 90 may detect the fluid level utilizing a float.

The stroke sensor 92 is configured to detect the stroke of the electric piston member 42. The stroke sensor 92 may detect the stroke by detecting a position of the rod portion 46 or the piston portion 47 relative to the housing 40, for instance.

The rotational speed sensor 94 is configured to detect the rotational speed of the electric motor 44. The stroke of the electric piston member 42 can be obtained based on the rotational speed of the electric motor 44.

Each wheel speed sensor 100 is provided for a corresponding one of the four wheels W, i.e., the front right and left wheels and the rear right and left wheels, for detecting the rotational speed of the corresponding wheel W. Based on the detection values of the four wheel speed sensors 100, a running speed of the vehicle and a slipping state of each wheel W are obtained.

Each hydraulic pressure sensor 102 is configured to detect a hydraulic pressure in the hydraulic pressure chamber 26 of the wheel cylinder 25 of the hydraulic brake 10 provided for a corresponding one of the four wheels W. (Hereinafter, the hydraulic pressure in the hydraulic pressure chamber 26 will be simply referred to as the hydraulic pressure of the hydraulic brake 10 or the hydraulic pressure of the wheel cylinder 25 where appropriate.) In most cases, the hydraulic pressure sensor 102 is provided in the fluid passage 74.

As illustrated in FIG. 3, power sources V are provided for the electric cylinder devices 12 in one-to-one correspondence. The power source V may be a lithium-ion battery or a capacitor, for instance. The electric cylinder devices, namely, the brake ECUs 86, the drive circuits 88, the fluid level sensors 90, the stroke sensors 92, the rotational speed sensors 94, the wheel speed sensors 100, the hydraulic pressure sensors 102, etc., can be operated by the corresponding power sources V, in other words, by the individual power sources V provided exclusively for the corresponding electric cylinder devices 12.

To the brake ECUs 86, namely, to the brake ECUs 86FL, 86FR, 86RL, 86RR respectively provided for the four wheels WFL, WFR, WRL, WRR, a driving support ECU 96, which is constituted principally by a computer, is connected via an in-vehicle communication network such as a CAN (Controller Area Network) 95. In the present embodiment, the driving support ECU 96 and the brake ECUs 86 perform communication via the CAN 95, and the four brake ECUs 86 perform communication with one another. The driving support ECU 96 outputs a brake request to each electric cylinder device 12. The driving support ECU 96 obtains and outputs a required braking force to each electric cylinder device 12. To the driving support ECU 96, an operation-state detecting device 104 and a surroundings-information obtaining device 106 are connected.

The operation-state detecting device 104 detects an operation state of a brake operation member (not illustrated) operable by the driver. Examples of the operation state of the brake operation member are a stroke, an operation force of the brake operation member.

The surroundings-information obtaining device 106 includes cameras, a radar device, etc. The surroundings-information obtaining device 106 obtains information on surroundings of the own vehicle such as an object present in surroundings of the own vehicle, a lane line of a road in the surroundings of the own vehicle, a curved state of a road, etc., and obtains a relative positional relationship between the object and the own vehicle.

In the hydraulic brake system constructed as described above, the driving support ECU 96 determines the presence or absence of the brake request based on the operation state of the brake operation member detected by the operation-state detecting device 104, the relative positional relationship between the own vehicle and the object present in the surroundings of the own vehicle obtained by the surroundings-information obtaining device 106, etc. When the brake request is present, the driving support ECU 96 obtains the required braking force for each wheel W based on the operation state of the brake operation member, the relative positional relationship between the own vehicle and the object present in the surroundings of the own vehicle, etc. The obtained required braking forces are supplied respectively to the electric cylinder devices 12, namely, to the brake ECUs 86.

Based on the required braking force, each brake ECU 86 obtains a target hydraulic pressure of the corresponding hydraulic brake 10 and controls the supply current to the corresponding electric motor 44 such that an actual hydraulic pressure, which is a detection value by the corresponding hydraulic pressure sensor 102, is brought closer to the target hydraulic pressure, so as to move the corresponding electric piston member 42 forward or backward.

When the electric piston member 42 is moved forward in the electric cylinder device 12, the volume of the volume change chamber 67 is decreased and the working fluid is supplied to the hydraulic pressure chamber 26 of the wheel cylinder 25, so that the hydraulic pressure of the wheel cylinder 25 is increased. When the electric piston member 42 is moved backward in the electric cylinder device 12, the volume of the volume change chamber 67 is increased and the working fluid flows out of the hydraulic pressure chamber 26 of the wheel cylinder 25, so that the hydraulic pressure of the wheel cylinder 25 is lowered. The supply current to the electric motor 44 is controlled to move the electric piston member 42 forward or backward, such that the hydraulic pressure of the wheel cylinder 25 is brought closer to the target hydraulic pressure.

When the brake request is canceled, the electric piston member 42 is returned in the electric cylinder device 12, so that the idle port 72 is opened and the hydraulic pressure chamber 26 is brought into communication with the reservoir 50. The electric piston member 42 is returned to the position indicated above where the electric piston member 42 comes into contact with the stopper. In the wheel cylinder 25, the wheel-side piston 27 is returned by the piston seal 28 to cause the friction pads 21, 22 to be separated away from the brake rotor 20. Thus, the hydraulic brake 10 is placed in a non-operating state.

When slipping of any of the wheels W becomes excessive, a slip reduction control is executed. In the slip reduction control, the electric piston member 42 is moved backward or forward by controlling the supply current to the electric motor 44 to thereby decrease or increase the hydraulic pressure in the hydraulic pressure chamber 26 of the wheel cylinder 25. Thus, a slip rate of the wheel W in question is determined so as to fall within an appropriate range determined based on a friction coefficient of the road surface.

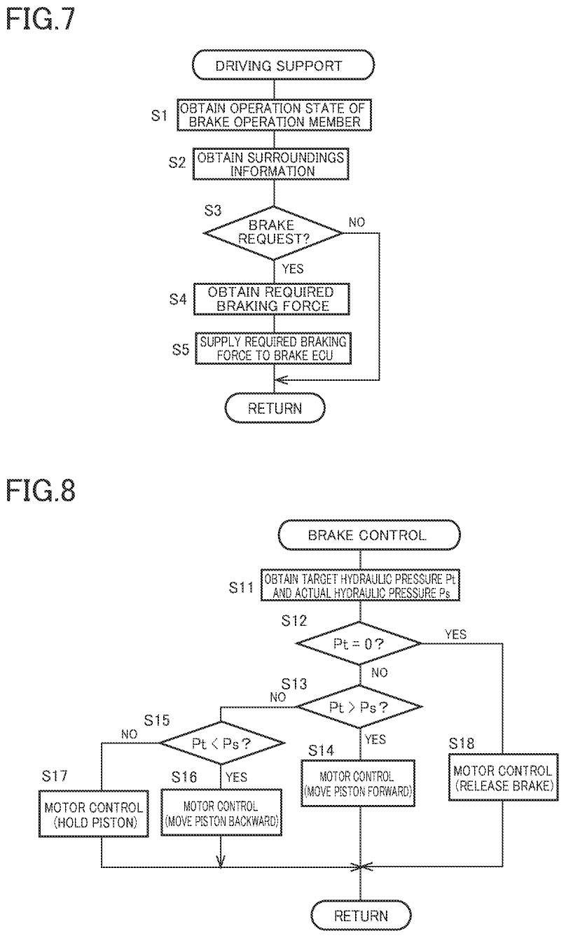

A normal-condition brake control program represented by a flowchart of FIG. 7 is executed by the driving support ECU 96 at intervals of a predetermined cycle time. Here, the normal condition refers to a condition in which no abnormality is detected in the electric cylinder devices 12, etc.

At Step 1, the operation state of the brake operation member detected by the operation-state detecting device 104 is obtained. (Hereinafter, Step 1 will be abbreviated as “S1”, and other steps will be similarly abbreviated.) S1 is followed by S2 to obtain the information indicative of the relative positional relationship between the own vehicle and the object present in the surroundings of the own vehicle obtained by the surroundings-information obtaining device 106. It is then determined at S3 whether the brake request is present based on the operation state of the brake operation member and the surroundings information. When the vehicle is braking, it is determined that the brake request is present. When an affirmative determination (YES) is made at S3, the required braking forces for the respective wheels W are obtained at S4. At S5, the required braking forces are supplied to the brake ECUs 86 of the corresponding wheels W.

A motor control program represented by a flowchart of FIG. 8 is executed by each brake ECU 86 at intervals of a predetermined cycle time. The following description about the motor control program will be made focusing on one brake ECU 86.

At S11, the target hydraulic pressure Pt is obtained based on the required braking force, and an actual hydraulic pressure Ps, which is a measured value of the hydraulic pressure sensor 102, is obtained. It is then determined at S12 whether the target hydraulic pressure Pt is 0. The target hydraulic pressure Pt is determined to be 0 when the required braking force is not obtained.

When a negative determination (NO) is made, it is determined at S13 whether the target hydraulic pressure Pt is greater than the actual hydraulic pressure Ps. When an affirmative determination (YES) is made, the control flow proceeds to S14 at which the electric motor 44 is controlled to cause the electric piston member 42 to move forward against the elastic force of the return spring 68. As a result, the volume of the volume change chamber 67 is decreased, and the hydraulic pressure of the wheel cylinder 25 is increased.

When a negative determination (NO) is made at S13, it is determined at S15 whether the actual hydraulic pressure Ps is greater than the target hydraulic pressure Pt. When an affirmative determination (YES) is made, the control flow proceeds to S16 at which the electric motor 44 is controlled to cause the electric piston member 42 to move backward. As a result, the volume of the volume change chamber 67 is increased, and the hydraulic pressure of the wheel cylinder 25 is decreased.

When a difference between the target hydraulic pressure Pt and the actual hydraulic pressure Ps is small and the target hydraulic pressure Pt and the actual hydraulic pressure Ps are substantially the same, the control flow proceeds to S17 at which the position of the electric piston member 42 is held and the hydraulic pressure is held. When an affirmative determination (YES) is made at S12, namely, when the target hydraulic pressure Pt is 0, the control flow proceeds to S18 at which the electric motor 44 is controlled to cause the electric piston member 42 to move backward to the rear end position.

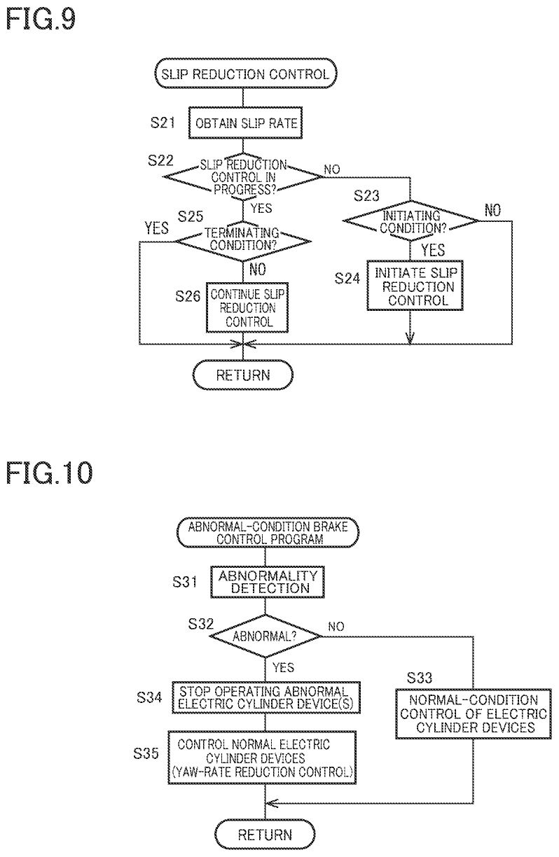

Each brake ECU 86 executes a slip reduction control program represented by a flowchart of FIG. 9. The following description about the slip reduction control program will be made focusing on one brake ECU 86.

At S21, the slip rate of the wheel W is obtained. The slip rate is obtained based on a speed of the vehicle body and the wheel speed. The speed of the vehicle body (hereinafter referred to as “vehicle body speed” where appropriate) is obtained by communication among the brake ECUs 86FL, 86FR, 86RL, 86RR, for instance. The brake ECU 86 obtains the vehicle body speed Vh based on the wheel speed Vwa detected by the wheel speed sensor 100 connected to itself and the wheel speeds Vwb, Vwc, Vwd received via the CAN 95. The brake ECU 86 obtains the slipping state of the wheel W based on the vehicle body speed Vh and the wheel speed Vwa detected by the wheel speed sensor 100 connected to itself The vehicle body speed Vh changes slowly, as compared with the wheel speed Vw. It is thus possible to utilize the value obtained based on the information received via the CAN 95.

At S22, it is determined whether the slip reduction control is in progress. When a negative determination (NO) is made, it is determined at S23 whether an initiating condition such as an excessive slip rate is satisfied. When an affirmative determination (YES) is made, the slip reduction control is initiated at S24. In a case where the present program is executed next time, the slip reduction control is in progress. Thus, it is determined at S25 whether a terminating condition such as a reduction in the slip rate is satisfied. When a negative determination (NO) is made, the slip reduction control is continuously executed at S26. The target hydraulic pressure is obtained to reduce the slip rate, and the electric motor 44 is controlled such that the actual hydraulic pressure is brought closer to the target hydraulic pressure. When an affirmative determination (YES) is made at S25 after repeated execution of S21, S22, S25, S26, the slip reduction control is terminated.

As described above, in the present embodiment, each of the brake ECUs 86 obtains the target hydraulic pressure based on the slipping state of the corresponding wheel W. Thus, the brake ECUs 86 execute the slip reduction control independently of each other. It is not essential for the brake ECUs 86 to execute the slip reduction control independently of each other. The driving support ECU 96 may obtain the required braking forces, and the obtained required braking forces may be supplied respectively to the brake ECUs 86.

In the present embodiment, the presence or absence of abnormality is detected for each of the electric cylinder devices 12.

For instance, the brake ECUs 86 output, to the CAN 95, the vehicle body speeds Vha obtained by the respective brake ECUs 86, and each of the brake ECUs 86 determines whether there exist an abnormal value or values in the four vehicle body speeds (Vha, Vhb, Vhc, Vhd). In a case where there exist a value or values that greatly deviate from an average value Vh of the four vehicle body speeds (Vha, Vhb, Vhc, Vhd), the value or values in question are determined to be abnormal, and the brake ECU or ECUs 86, which have obtained the abnormal value or values, are determined to be abnormal. Based on the determination results by the respective brake ECUs 86, the abnormal brake ECU or ECUs 86 are determined finally based on majority rule, for instance. The determination of the abnormal brake ECU or ECUs 86, namely, the determination of the abnormal electric cylinder device or devices 12, may be made by the driving support ECU 96 or by one of the plurality of brake ECUs 86, for instance.

The driving support ECU 96 may receive the vehicle body speeds (Vha, Vhb, Vhc, Vhd) respectively obtained by the brake ECUs 86, may detect the abnormal value or values based on the four vehicle body speeds (Vha, Vhb, Vhc, Vhd), and may determine that the brake ECU or ECUs 86, which have output the abnormal value or values, are abnormal.

The presence or absence of abnormality of each electric cylinder device 12 may be detected according to any suitable method. The presence or absence of abnormality may be detected based on a deviation of the actual hydraulic pressure detected by the hydraulic pressure sensor 102 with respect to the target hydraulic pressure. The presence or absence of abnormality may be detected based on a relationship between the hydraulic pressure detected by the hydraulic pressure sensor 102 and the stroke of the electric piston member 42 obtained based on the detection value by the rotational speed sensor 94.

When at least one of the four electric cylinder devices 12 is determined to be abnormal, the electric cylinder device 12 in question stops operating and other normal electric cylinder devices 12 are operated.

FIG. 10 illustrates one example of a flowchart representing an abnormal-condition brake control program. At S31, the presence or absence of abnormality is detected for each electric cylinder device 12. At S32, it is determined whether at least one of the electric cylinder devices 12 is abnormal. When a negative determination (NO) is made, the electric cylinder devices 12 are controlled according to the control in the normal condition. As described above, the electric cylinder devices 12 are controlled according to the normal-condition brake control program represented by the flowchart of FIG. 7. For instance, the electric motor 44 of each electric cylinder device 12 is controlled such that the hydraulic pressure detected by the hydraulic pressure sensor 102 is brought closer to the target hydraulic pressure determined based on the relative positional relationship between the own vehicle and the object present in the surroundings of the vehicle, the operation state of the brake operation member, etc. When an affirmative determination (YES) is made at S32, the abnormal electric cylinder device 12 stops operating at S34 and the normal electric cylinder devices 12 are controlled at S35. In a case where the electric cylinder device 12RL of the rear left wheel WRL is determined to be abnormal, the electric cylinder device 12RL of the rear left wheel WRL stops operating and the normal three electric cylinder devices, i.e., the electric cylinder devices 12FL, 12FR, 12RR of the front left wheel WFL, the front right wheel WFR, and the rear right wheel WRR, are operated. Each of the electric cylinder devices 12FL, 12FR, 12RR is preferably controlled to reduce a yaw rate of the vehicle that arises from stopping of the electric cylinder device 12RL of the rear left wheel WRL. The yaw rate may be reduced by controlling a regenerative braking force by a regenerative brake device (not illustrated).

In the present embodiment, a first vehicle (as one example of the vehicle) includes the four electric cylinder devices 12. Thus, even when part of the four electric cylinder devices 12 suffers from abnormality, the electric cylinder devices 12 not suffering from abnormality enable the hydraulic pressures to be generated in the wheel cylinders 25 of the corresponding hydraulic brakes 10. This enables the present hydraulic brake system to be operated continuously. Further, when part of the four electric cylinder devices 12 fails to operate, the hydraulic brake system can be continuously operated even if the brake operation member is not operated. Thus, the hydraulic brake system according to the present embodiment is a fail operative system. The fail operative system may also be referred to as a fail operatable system.

In a case where the first vehicle is an automated driving vehicle, the driver does not notice that part of the electric cylinder devices 12 suffers from a trouble. In this case, the part of the electric cylinder devices 12 may fail to operate. Further, in a case where the owner of the vehicle neglects maintenance of the vehicle, part of the electric cylinder devices 12 may fail to operate. The present hydraulic brake system can be operated continuously even in those cases.

In the present hydraulic brake system, the power sources V are provided for the electric cylinder devices 12 in one-to-one correspondence. Thus, even when one of the four power sources V fails to operate, the electric cylinder devices 12 corresponding to the other three power sources V can be operated.

Likewise, the brake ECUs 86 are provided for the electric cylinder devices 12 in one-to-one correspondence. Thus, even when one of the four brake ECUs 86 fails to operate, the electric cylinder devices 12 corresponding to the other three brake ECUs 86 can be operated. It is noted that the driving support ECU 96, the operation-state detecting device 104, and the surroundings-information obtaining device 106 may be configured to have redundancy.

Even when part of constituent elements of a hydraulic brake system suffers from abnormality, the hydraulic brake system can operate continuously by other constituent elements not suffering from abnormality. Such a hydraulic brake system is referred to as a fail operative system. In this instance, in terms of the probability of occurrence of a failure, the hydraulic brake system needs to have three or more mutually independent hydraulic pressure sources (including the electric cylinder devices 12, for instance). The hydraulic brake system of the present embodiment includes the electric cylinder devices 12 as four hydraulic pressure sources. Thus, the present hydraulic brake system is a fail operative system.

In the hydraulic brake system of the present embodiment, though the electric cylinder devices 12 are provided so as to correspond to the respective wheel cylinders 25, power consumption of each electric cylinder device 12 is reduced as described above. This reduces or prevents an increase in power consumption of the vehicle as a whole though the number of electric motors 44 mounted on the vehicle is increased. It is thus possible to mount the four electric motors 44 on the first vehicle.

For instance, a vehicle whose weight is 3.5 t-8 t(as one example of the first vehicle) needs a large braking force for stopping, thus requiring a large amount of the working fluid to be supplied to each of the wheel cylinders respectively provided for the four wheels W. In this case, a conventional hydraulic brake system undesirably suffers from a problem of an increase in size of the master cylinder, an electric booster, and so on.

In contrast, the hydraulic brake system of the present embodiment includes the electric cylinder devices 12 provided so as to correspond to the respective wheel cylinders 25. In other words, it is not needed to increase the size of each electric cylinder device 12 for supplying the working fluid in an amount required by one wheel cylinder 25. As described above, the stroke of the electric piston member 42 is made large (e.g., not less than 50 mm), and the pressure receiving area of the piston portion 47 can be made small (e.g., not greater than 30 mm). This enables the pressure receiving area ratio to be increased, so that the axial force applied to the rotation-linear motion converting device 48 can be decreased and power consumption of the electric motor 44 can be accordingly reduced. Thus, the four electric motors 44 can be mounted on the first vehicle without the necessity to increase the size of a battery (not illustrated) of the first vehicle.

In a case where the first vehicle is a commercial vehicle, constituent elements of a hydraulic brake system such as the master cylinder, the electric booster, and an electromagnetic valve device including at least one electromagnetic valve are usually replaced on a regular basis for obviating a failure of the constituent elements. As for the electromagnetic valve device, in particular, it is difficult to replace and install the electromagnetic valves individually, and the entirety of the electromagnetic valve device, namely, a whole unit, is replaced. In such a case, the maintenance cost tends to be high, and a large amount of wastes are disposed of

The present embodiment eliminates the need to replace the entirety of each electric cylinder device 12 on a regular basis. Instead, the electric cylinder device 12 is disassembled, and a component or components suffering from abnormality can be easily replaced. For instance, rubber members such as the seal member 66 are more likely to be deteriorated than metal members. In the present embodiment, only the seal member 66 can be replaced. This leads to a reduction in the maintenance cost. Further, wastes to be disposed of can be reduced, resulting in effective utilization of resources.

In a case where the vehicle is large-sized and the volume of each hydraulic brake 10 is large, the hydraulic pressure at a time when the brake starts to be effective is high, and the diameter of the wheel-side piston 27 is large. It is thus required to supply a large amount of the working fluid before the brake starts to be effective. If the diameter of the electric piston member 42 of the electric cylinder device 12 is reduced, the stroke of the electric piston member 42 before braking starts to be effective becomes long, causing a delay in brake response. As for the electric motor 44, a field weakening technique is available. According to the field weakening technique, in a period during which the reaction force of the electric piston member 42 is small before the brake starts to be effective, a current is supplied in an amount larger than an amount that achieves a specific rotational speed. By thus supplying a larger amount of the current, the rotational speed of the electric motor 44 is increased and the speed of the forward movement of the electric piston member 42 is increased, enabling the stroke to be immediately increased and preventing or reducing a delay in brake response.

Also in a case where the electric cylinder device 12 has a structure that enables a large amount of the working fluid to be supplied to the wheel cylinder 25 at the start of the operation (hereinafter referred to as a fill-up structure), the speed of the forward movement of the electric piston member 42 before the brake starts to be effective can be increased, thus preventing or reducing a delay in brake response.

In the present embodiment, a hydraulic-pressure control device is constituted by the wheel speed sensors 100, the hydraulic pressure sensors 102, the operation-state detecting device 104, the surroundings-information obtaining device 106, the driving support ECU 96, the brake ECUs 86, etc. For instance, a portion of the hydraulic-pressure control device that stores and executes S31 of the abnormal-condition brake control program represented by the flowchart of FIG. 10 corresponds to an abnormality detecting portion.

Transmission and reception of information between the driving support ECU 96 and the brake ECUs 86, division of roles, etc., are not limited to those in the illustrated embodiment, but may be otherwise set.

The vehicle on which the present hydraulic brake system is installed may be an automated driving vehicle, a manual driving vehicle of a by-wire type (in which the operation state of the brake operation member is detected by the operation-state detecting device 104 and the electric cylinder devices 12 are controlled based on the detected operation state of the brake operation member), or a vehicle capable of switching a driving state between a manual driving state and an automated driving state. The present hydraulic brake system is applicable to a vehicle having four or more wheels.

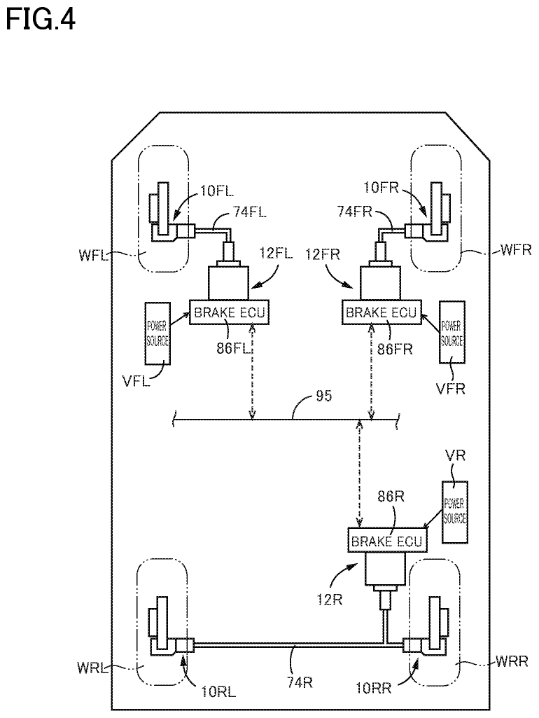

In the embodiment illustrated above, the electric cylinder devices 12 are mounted on the first vehicle. The electric cylinder devices 12 are mountable on a second vehicle whose weight is smaller than that of the first vehicle. In the hydraulic brake system installed on the second vehicle illustrated in FIG. 4, the electric cylinder devices 12FL, 12FR are provided for the hydraulic brakes 10FL, 10FR of the front left and right wheels WFL, WFR in one-to-one correspondence via the respective fluid passages 74FL, 74FR, and one electric cylinder device 12R is provided in common for the hydraulic brakes 1ORL, 1ORR of the rear left and right wheels WRL, WRR. The wheel cylinders 25 of the hydraulic brakes 10RL, 10RR of the rear left and right wheels WRL, WRR are connected to the fluid passage 74R in which the electric cylinder device 12R is provided. Further, the power sources VFL, VFR, VR and the brake ECUs 86FL, 86FR, 86R are provided in one-to-one correspondence with the electric cylinder devices 12FL, 12FR, 12R.

In the slip reduction control (such as an antilock control or a traction control executed in a case where the rear wheels WRL, WRR are drive wheels), the electric cylinder device 12R causes the hydraulic pressures in the wheel cylinders 25RL, 25RR to increase or decrease based on a smaller one of the wheel speeds of the rear left and right wheels WRL, WRR, namely, based on a greater one of the slip rates of the rear left and right wheels WRL, WRR. This slip reduction control is referred to as a low-select control.

The hydraulic brake system installed on the second vehicle includes the three electric cylinder devices 12 and is referred to as a fail operative system.

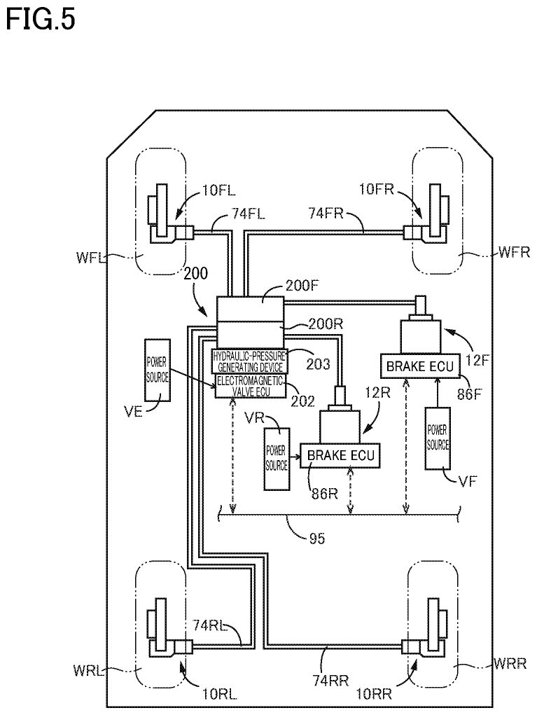

As illustrated in FIG. 5, the electric cylinder devices 12 are mountable on a third vehicle whose weight is smaller than that of the second vehicle. In the hydraulic brake system installed on the third vehicle, one electric cylinder device 12F is provided in common for the hydraulic brakes 10FL, 10FR of the front left and right wheels WFL, WFR, and one electric cylinder device 12R is provided in common for the hydraulic brakes 10RL, 10RR of the rear left and right wheels WRL, WRR. Specifically, the wheel cylinders 25 of the hydraulic brakes 10FL, 10FR of the front left and right wheels WFL, WFR are connected to a front-wheel-side electromagnetic valve device 200F via the respective fluid passages 74FL, 74FR, and the electric cylinder device 12F is connected to the front-wheel-side electromagnetic valve device 200F. Further, the wheel cylinders 25 of the hydraulic brakes 10RL, 10RR of the rear left and right wheels WRL, WRR are connected to a rear-wheel-side electromagnetic valve device 200R via the respective fluid passages 74RL, 74RR, and the electric cylinder device 12R is connected to the rear-wheel-side electromagnetic valve device 200R.

In the present embodiment, the front-wheel-side electromagnetic valve device 200F and the rear-wheel-side electromagnetic valve device 200R are hydraulically independent of each other. In this configuration, abnormality that occurs in one of the front-wheel-side electromagnetic valve device 200F and the rear-wheel-side electromagnetic valve device 200R does not influence the other of the front-wheel-side electromagnetic valve device 200F and the rear-wheel-side electromagnetic valve device 200R. The front-wheel-side electromagnetic valve device 200F and the rear-wheel-side electromagnetic valve device 200R, etc., constitute an electromagnetic valve device 200. The electromagnetic valve device 200 includes a hydraulic-pressure generating device 203, for instance. The hydraulic-pressure generating device 203 may include, for instance, pumps provided respectively for the front-wheel-side electromagnetic valve device 200F and the rear-wheel-side electromagnetic valve device 200R and one electric motor for driving the two pumps provided in common to the two pumps. The power sources VF, VR are provided respectively for the electric cylinder devices 12F, 12R, and the power source VE is provided for the electromagnetic valve device 200. Likewise, the brake ECUs 86F, 86R, each of which is constituted principally by a computer, are provided respectively for the electric cylinder devices 12F, 12R. One electromagnetic valve ECU 202 is provided in common for the front-wheel-side electromagnetic valve device 200F and the rear-wheel-side electromagnetic valve device 200R.

Thus, the hydraulic brake system installed on the third vehicle includes the two electric cylinder devices 12F, 12R and at least one hydraulic-pressure generating device 203 and is referred to as a fail operative system including front and rear lines.

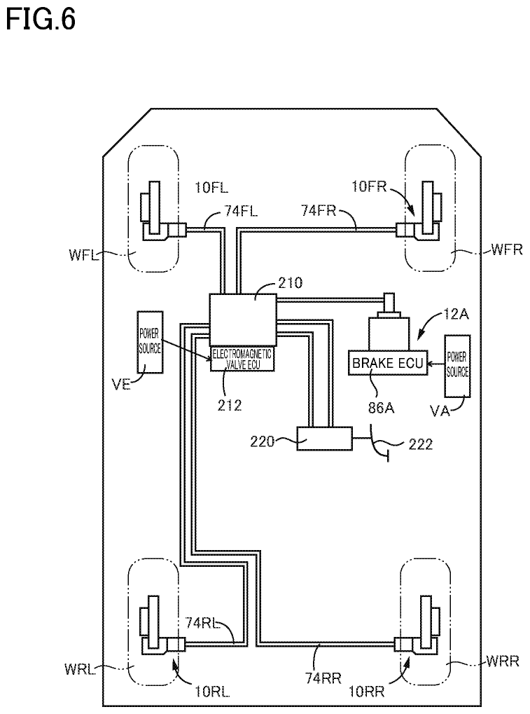

As illustrated in FIG. 6, the electric cylinder devices 12 are mountable on a fourth vehicle whose weight is smaller than that of the third vehicle. In the hydraulic brake system installed on the fourth vehicle, one electric cylinder device 12A is provided in common for the hydraulic brakes 10FL, 10FR, 10RL, 10RR of the respective four wheels WFL, WFR, WRL, WRR. The electric cylinder device 12A is connected to an electromagnetic valve device 210. The wheel cylinders 25 of the hydraulic brakes 10FL, 10FR, 10RL, 10RR are connected to the electromagnetic valve device210 via the respective fluid passages 74FL, 74FR, 74RL, 74RR. The hydraulic pressure generated by the electric cylinder device 12A is supplied to the wheel cylinders 25 of the respective hydraulic brakes 10 via the electromagnetic valve device 210, and the electromagnetic valve device 210 is controlled to individually control the hydraulic pressures of the wheel cylinders 25. The power source VA and the brake ECU 86A are provided for the electric cylinder device 12A, and the power source VE and an electromagnetic valve ECU 212 are provided for the electromagnetic valve device 210.

In a case where the fourth vehicle illustrated in FIG. 6 is a vehicle capable of performing manual driving, a manual hydraulic pressure source (such as a master cylinder) 220 may be provided in parallel with the electric cylinder device 12A. For instance, both the manual hydraulic pressure source 220 and the electric cylinder device 12 may be connected to the electromagnetic valve device 210. In this instance, when the electric cylinder device 12A fails to operate, the hydraulic pressure is generated in the manual hydraulic pressure source 220 by an operation of the brake operation member 222, and the generated hydraulic pressure is supplied to the wheel cylinders 25 to generate the hydraulic pressures in the hydraulic brakes 10.

When the electric cylinder device 12A fails to operate, the hydraulic brake system constructed as described above causes the electric cylinder device 12A to stop operating and causes the vehicle to stop by a driver's manual operation of the brake operation member 222. This hydraulic brake system may be referred to as a fail-safe system in which the electric cylinder device 12A stops operating in case of abnormality and the vehicle is stopped by the driver's manual operation of the brake operation member 222.

As described above, the same electric cylinder device 12 can be utilized for vehicles different in weight such as the first vehicle, the second vehicle, the third vehicle, and the fourth vehicle by changing the number of the electric cylinder devices 12 mounted. In other words, the braking forces respectively required for the first vehicle, the second vehicle, the third vehicle, and the fourth vehicle can be applied by one or more electric cylinder devices 12 common to those vehicles. The electric cylinder device 12 can be utilized in a variety of vehicles in common, achieving a cost reduction as a whole. A further cost reduction is achieved in particular when the present configuration is applied to vehicles produced in small quantities.

For instance, the number of vehicles sold greatly differs among vehicles that are different in size. If components are developed dedicatedly for the small number of vehicles sold, the development cost and the mold cost are divided by the small number of vehicles, thus pushing up the component cost. If the same electric cylinder device 12 is used for a variety of vehicles regardless of the number of vehicles sold, the cost for one electric cylinder device 12 can be reduced even though the number of the electric cylinder devices 12 mounted differs among the vehicles. This leads to a cost reduction as a whole.

The hydraulic system can be either a fail operative system or a fail-safe system by changing the number of the electric cylinder devices 12 depending upon whether the vehicle has an automated driving function, for instance. The present disclosure eliminates the need of developing hydraulic systems individually for vehicles in different types, thus obviating a factor in pushing up the cost.

The electric cylinder devices 12 that are identical in structure can be applied in common to a variety of vehicles by changing specifications, for instance. The electric cylinder devices 12 that are identical in structure can be applied in common to a variety of vehicles without newly designing the structure. In other words, by saying that “the electric cylinder devices 12 are used in common”, it means that “the electric cylinder devices 12 that are identical in structure are used”. The specifications such as the power of the electric motor 44, the shapes of the electric piston member 42, the cylinder bore, etc., are not limited to particular ones.

For instance, the magnitude of the axial force is adjusted by changing the number of turns or the diameter of the coils of the electric motor 44 depending on the size of the vehicle, the type of the vehicle, etc. The maximum stroke of the electric piston member 42 is changed depending on the volume of the wheel cylinder 25 connected thereto, for instance.

By changing the specifications of the electric cylinder device 12, the hydraulic brakes 10 and the electric cylinder devices 12 can be provided in one-to-one correspondence in a variety of vehicles.

The electric cylinder device 12 may be connected directly to the wheel cylinder 25 or may be connected to the electromagnetic valve device.

The electric cylinder device 12 and the wheel cylinder 25 may be provided in one-to-one correspondence or in one-to-many correspondence, for instance. The number of the electric cylinder devices 12 may be designed depending on the required braking force. The electric cylinder device 12 can be disposed so as to be connected to the fluid passage that extends from the wheel cylinder of the hydraulic brake of the wheel W. With this configuration, the position of the electric cylinder device 12 can be relatively freely determined. The stroke, the diameter, etc., of the electric piston member 42 of each electric cylinder device 12 may be designed depending on the required braking force. As described above, the electric cylinder device 12 can be used in common to a variety of vehicles and is easy to handle. Because the electric cylinder device 12 can be used in common, the electric cylinder device 12 or its constituent elements can be recycled, allowing effective utilization of resources.

The electric cylinder device 12 may be otherwise constructed. The electric motor 44 and the rod portion 46 need not necessarily be coaxially disposed but may be parallely disposed.

A speed reducer may be provided between the electric motor 44 and the rod portion 46.

In the embodiments illustrated above, while the hydraulic-pressure control device includes the driving support ECU 96, the brakes ECUs 86, etc., the hydraulic-pressure control device may be configurd otherwise. For instance, the hydraulic-pressure control device may be configured to include a single ECU.

In the embodiments illustrated above, the hydraulic brake system executes the slip reduction control and the control in which the hydralulic pressure of each wheel cylinder 25 is brought closer to the target hydraulic pressure determined based on the surrounding situation and the operation state of the brake operation member. The present disclosure is not limited to this configuration. For instance, the hydraulic brake system may execute various controls such as a control of distributing the braking force between the front wheels and the rear wheels.

It is to be understood that the present disclosure is not limited to the details of the illustrated embodiments, but may be embodied with various changes and modifications, which may occur to those skilled in the art. For instance, the hydraulic brake 10 may be a disc brake or a drum brake.

### CLAIMABLE INVENIONS

(1) A hydraulic brake system, including:
a plurality of hydraulic brakes respectively provided for a plurality of wheels of a vehicle, each of the plurality of hydraulic brakes being configured to reduce rotation of a corresponding one of the wheels by a hydraulic pressure in a hydraulic-pressure chamber of a wheel cylinder: and
a plurality of electric cylinder devices each of which is provided for one or more of the plurality of hydraulic brakes,
wherein each of the plurality of electric cylinder devices includes: a housing; a piston fluid-tightly and slidably disposed in the housing; an electric motor as a drive source; a rotation-linear motion converting mechanism configured to convert a rotational motion of the electric motor to a linear motion of the piston; and a volume change chamber disposed forward of the piston and connected to the hydraulic-pressure chamber of the wheel cylinder of each of the one or more of the plurality of hydraulic brakes.

The hydraulic brakes and the electric cylinder devices may be provided in one-to-one correspondence or in two-to-one correspondence. The hydraulic brake system according to this form includes a plurality of electric cylinder devices.

(2) The hydraulic brake system according to the form (1), wherein each of the plurality of electric cylinder devices includes a reservoir configured to store a working fluid returned from the hydraulic-pressure chamber of the wheel cylinder of each of the one or more of the plurality of hydraulic brakes.

(3) The hydraulic brake system according to the form (2),
wherein each of the plurality of electric cylinder devices includes two ports formed at a portion of the housing surrounding the volume change chamber so as to be spaced apart from each other in an axial direction of the piston,
wherein the reservoir is connected to a rear port that is one of the two ports located more rearward than the other of the two ports in a direction in which the piston moves backward, and
wherein the rear port is open when the piston is located at a rear end position thereof and is closed when the piston moves forward.

The ports are open to the volume change chamber.

(4) The hydraulic brake system according to the form (3), wherein the hydraulic-pressure chamber of the wheel cylinder of each of the one or more of the plurality of hydraulic brakes is directly connected to a front port of each of the plurality of electric cylinder devices, the front port being the other of the two ports located more forward than the one of the two ports in a direction in which the piston moves forward.

The front port is open all the time and permits the volume change chamber and the wheel cylinder to be held in communication with each other. The volume change chamber and the wheel cylinder are connected to each other via the fluid passage. In some case, an electromagnetic valve or the like is provided in the fluid passage. In other case, no electromagnetic valve or the like is provided in the fluid passage.

(5) The hydraulic brake system according to any one of the forms (1)-(4),
wherein the hydraulic brake system includes a plurality of power sources, and
wherein the plurality of power sources and the plurality of electric cylinder devices are provided in one-to-one correspondence.

The plurality of power sources may be preferably independent of one another.

(6) The hydraulic brake system according to any one of the forms (1)-(5), including a plurality of controllers each of which is constituted principally by a computer,
wherein the plurality of controllers and the plurality of electric cylinder devices are provided in one-to-one correspondence.

(7) The hydraulic brake system according to any one of the forms (1)-(6), wherein the plurality of electric cylinder devices and the plurality of hydraulic brakes are provided in one-to-one correspondence.

(8) The hydraulic brake system according to any one of the forms (1)-(7), including three or more electric cylinder devices as the plurality of electric cylinder devices.

For instance, the vehicle may include four wheels as the plurality of wheels, and the hydraulic brake system may be configured such that four hydraulic brakes are respectively provided for the four wheels and one of three or more electric cylinder devices as the plurality of electric cylinder devices is provided so as to correspond to one or two of the four hydraulic brakes.

(9) The hydraulic brake system according to any one of the forms (1)-(8), including two electric cylinder devices as the plurality of electric cylinder devices and at least one hydraulic-pressure generating device different from the plurality of electric cylinder devices in structure.

The hydraulic-pressure generating device may be a power-assisted hydraulic-pressure generating device such as a pump device. Here, the power-assisted hydraulic-pressure generating device refers to a hydraulic-pressure generating device that is not a manual hydraulic-pressure generating device. One or two hydraulic-pressure generating devices may be provided in the hydraulic brake system.

For instance, the vehicle may include four wheels, i.e., front right and left wheels and rear right and left wheels, and the hydraulic brake system may be configured such that four hydraulic brakes are respectively provided for the four wheels and each of two electric cylinder devices as the plurality of electric cylinder devices is provided in one-to-two correspondence with the hydraulic brakes provided respectively for two of the four wheels. At least one first electromagnetic valve may be provided between one of the two electric cylinder devices and corresponding two hydraulic brakes. At least one second electromagnetic valve, which is different from the at least one first electromagnetic valve, may be provided between the other of the two electric cylinder devices and corresponding two hydraulic brakes.

In the illustrated embodiment, the at least one first electromagnetic valve, etc., constitute one of a front-wheel-side electromagnetic valve device and a rear-wheel-side electromagnetic valve device while the at least one second electromagnetic valve, etc., constitute the other of the front-wheel-side electromagnetic valve device and the rear-wheel-side electromagnetic valve device.

(10) The hydraulic brake system according to any one of the forms (1)-(9), including a hydraulic-pressure control device configured to control a supply current to the electric motor of each of the plurality of electric cylinder devices to thereby control the hydraulic pressure in the hydraulic-pressure chamber of the wheel cylinder of each of the plurality of hydraulic brakes,
wherein the hydraulic-pressure control device controls the supply current to the electric motor of each of the plurality of electric cylinder devices to thereby cause the piston to move forward or backward for decreasing or increasing a volume of the volume change chamber of each of the plurality of electric cylinder devices, so as to increase or decrease the hydraulic pressure in the hydraulic-pressure chamber of the wheel cylinder of each of the plurality of hydraulic brakes.

The hydraulic-pressure generating device may be configured to include a plurality of controllers.

(11) The hydraulic brake system according to the form (10), including:
a surroundings-information obtaining device configured to obtain information on surroundings of the vehicle; and
wheel-speed detecting devices respectively provided for the plurality of wheels, each of the wheel-speed detecting devices being configured to detect a wheel speed that is a rotational speed of a corresponding one of the plurality of wheels,
wherein the hydraulic-pressure control device is configured to:
   control the supply currents to the respective electric motors such that the hydraulic pressure in the wheel cylinder of each of the plurality of hydraulic brakes is brought closer to a target hydraulic pressure determined based on at least the information on the surroundings of the vehicle obtained by the surroundings-information obtaining device; and
   control the supply currents to the respective electric motors such that a slipping state of each of the plurality of wheels, which is obtained based on the wheel speed detected by a corresponding one of the wheel-speed detecting devices, falls within an appropriate range determined by a friction coefficient of a road surface.

(12) The hydraulic brake system according to the form (10), including:
an operation-state detecting device configured to detect an operation state of a brake operation member operable by a driver of the vehicle;
a surroundings-information obtaining device configured to obtain information on surroundings of the vehicle; and
wheel-speed detecting devices respectively provided for the plurality of wheels, each of the wheel-speed detecting devices being configured to detect a wheel speed that is a rotational speed of a corresponding one of the plurality of wheels,
wherein the hydraulic-pressure control device is configured to:
   control the supply currents to the respective electric motors such that the hydraulic pressure in the wheel cylinder of each of the plurality of hydraulic brakes is brought closer to a target hydraulic pressure determined based on at least one of the information on surroundings of the vehicle obtained by the surroundings-information obtaining device and the operation state of the brake operation member detected by the operation state detecting device; and
   control the supply currents to the respective electric motors such that a slipping state of each of the plurality of wheels, which is obtained based on the wheel speed detected by a corresponding one of the wheel-speed detecting devices, falls within an appropriate range determined by a friction coefficient of a road surface.

In a case where the vehicle is an automated driving vehicle and does not include the brake operation member operable by a driver, the target hydraulic pressure is determined based on the information on the surroundings of the vehicle obtained by the surroundings-information obtaining device. In a case where the vehicle includes the brake operation member, the target hydraulic pressure is determined also based on the operation state of the brake operation member. For instance, the target hydraulic pressure may be determined based on the operation state of the brake operation member and/or the information on the surroundings of the vehicle.

(13) The hydraulic brake system according to any one of the forms (10)-(12),
wherein the hydraulic-pressure control device includes an abnormality detecting portion configured to detect the presence or absence of an abnormality of each of the plurality of electric cylinder devices, and
wherein, when the abnormality detecting portion detects that one or more of the plurality of electric cylinder devices are abnormal, the hydraulic-pressure control device stops operating the one or more of the plurality of electric cylinder devices determined to be abnormal and controls one or more of the plurality of electric cylinder devices except the one or more of the plurality of electric cylinder device determined to be abnormal.

In the hydraulic brake system according to this form, the one or more of the plurality of electric cylinder devices except the one or more of the plurality of electric cylinder devices determined to be abnormal can be controlled independently of each other.

(14) The hydraulic brake system according to any one of the forms (1)-(13),
wherein the housing includes a first housing in which the electric motor is housed and a second housing in which the piston is fluid-tightly and slidably disposed, and
wherein the first housing and the second housing are separably assembled.

The first housing and the second housing may be coupled by a coupler that includes screw members and nut members, for instance. With this configuration, the housing is disassembled into the first housing and the second housing by removing the nut members, thus enabling removal of the electric motor, the piston, the rotation-linear motion converting device, etc. The first housing corresponds to the rear housing 40r, and the second housing corresponds to the front housing 40f. The first housing 40r and the second housing 40f are coupled by the coupler that includes the screw members 80 and the nut members 82.

A cylinder bore is formed in the second housing. The cylinder bore may have an elongate shape. For instance, the cylinder bore may have a ratio between the diameter and the length (diameter/length) that is less than 0.6.

(15) The hydraulic brake system according to any one of the forms (1)-(14), which does not include i) a manual hydraulic pressure source configured to generate a hydraulic pressure based on an operation of a brake operation member by a driver of the vehicle and ii) a pump hydraulic-pressure source including a pump device and configured to generate a hydraulic pressure based on an operation of the pump device.

The manual hydraulic pressure source, the pump hydraulic pressure source, etc., are not connected to the electric cylinder device.

(16) The hydraulic brake system according to any one of the forms (1)-(15), wherein no electromagnetic valve, which is configured to be operated by application of a voltage to a solenoid thereof, is provided between each of the plurality of electric cylinder devices and each of the plurality of hydraulic brakes.

What is claimed is:

1. A hydraulic brake system, comprising:
a plurality of hydraulic brakes respectively provided for a plurality of wheels of a vehicle, each of the plurality of hydraulic brakes being configured to reduce rotation of a corresponding one of the wheels by a hydraulic pressure in a hydraulic-pressure chamber of a wheel cylinder; and
a plurality of electric cylinder devices each of which is provided for one or more of the plurality of hydraulic brakes,
wherein each of the plurality of electric cylinder devices includes: a housing; a piston fluid-tightly and slidably disposed in the housing; an electric motor as a drive source; a rotation-linear motion converting mechanism configured to convert a rotational motion of the electric motor to a linear motion of the piston; and a volume change chamber disposed forward of the piston and connected to the hydraulic-pressure chamber of the wheel cylinder of each of the one or more of the plurality of hydraulic brakes.

2. The hydraulic brake system according to claim 1, wherein each of the plurality of electric cylinder devices includes a reservoir configured to store a working fluid returned from the hydraulic-pressure chamber of the wheel cylinder of each of the one or more of the plurality of hydraulic brakes.

3. The hydraulic brake system according to claim 2,
wherein each of the plurality of electric cylinder devices includes two ports formed at a portion of the housing surrounding the volume change chamber so as to be spaced apart from each other in an axial direction of the piston,
wherein the reservoir is connected to a rear port that is one of the two ports located more rearward than the other of the two ports in a direction in which the piston moves backward, and
wherein the rear port is open when the piston is located at a rear end position thereof and is closed when the piston moves forward.

4. The hydraulic brake system according to claim 3, wherein the hydraulic-pressure chamber of the wheel cylinder of each of the one or more of the plurality of hydraulic brakes is directly connected to a front port of each of the plurality of electric cylinder devices, the front port being the other of the two ports located more forward than the one of the two ports in a direction in which the piston moves forward.

5. The hydraulic brake system according to claim 1,
wherein the hydraulic brake system includes a plurality of power sources, and
wherein the plurality of power sources and the plurality of electric cylinder devices are provided in one-to-one correspondence.

6. The hydraulic brake system according to claim 1, wherein the plurality of electric cylinder devices and the plurality of hydraulic brakes are provided in one-to-one correspondence.

7. The hydraulic brake system according to claim 1, comprising a hydraulic-pressure control device configured to control a supply current to the electric motor of each of the plurality of electric cylinder devices to thereby control the hydraulic pressure in the hydraulic-pressure chamber of the wheel cylinder of each of the plurality of hydraulic brakes,
wherein the hydraulic-pressure control device controls the supply current to the electric motor of each of the plurality of electric cylinder devices to thereby cause the piston to move forward or backward for decreasing or increasing a volume of the volume change chamber of each of the plurality of electric cylinder devices, so as to increase or decrease the hydraulic pressure in the hydraulic-pressure chamber of the wheel cylinder of each of the plurality of hydraulic brakes.

8. The hydraulic brake system according to claim 7, including:
an operation-state detecting device configured to detect an operation state of a brake operation member operable by a driver of the vehicle;
a surroundings-information obtaining device configured to obtain information on surroundings of the vehicle; and
wheel-speed detecting devices respectively provided for the plurality of wheels, each of the wheel-speed detecting devices being configured to detect a wheel speed that is a rotational speed of a corresponding one of the plurality of wheels,
wherein the hydraulic-pressure control device is configured to:
control the supply currents to the respective electric motors such that the hydraulic pressure in the wheel cylinder of each of the plurality of hydraulic brakes is brought closer to a target hydraulic pressure determined based on at least one of the information on surroundings of the vehicle obtained by the surroundings-information obtaining device and the operation state of the brake operation member detected by the operation state detecting device; and
control the supply currents to the respective electric motors such that a slipping state of each of the plurality of wheels, which is obtained based on the wheel speed detected by a corresponding one of the wheel-speed detecting devices, falls within an appropriate range determined by a friction coefficient of a road surface.

9. The hydraulic brake system according to claim 7,
wherein the hydraulic-pressure control device includes an abnormality detecting portion configured to detect the presence or absence of an abnormality of each of the plurality of electric cylinder devices, and
wherein, when the abnormality detecting portion detects that one or more of the plurality of electric cylinder devices are abnormal, the hydraulic-pressure control device stops operating the one or more of the plurality of electric cylinder devices determined to be abnormal and controls one or more of the plurality of electric cylinder devices except the one or more of the plurality of electric cylinder device determined to be abnormal.
